(19) United States
(12) Patent Application Publication
(10) Pub. No.: US 2025/0226199 A1
(43) Pub. Date: Jul. 10, 2025

(54) METHOD AND APPARATUS TO INCREASE SENSITIVITY OF INDUCTIVELY COUPLED PLASMA MASS SPECTROMETRY

(71) Applicant: Kimia Analytics Inc., Richmond Hill (CA)

(72) Inventors: Gholamreza JAVAHERY, Thornhill (CA); Sina ALAVI, North York (CA); Javad MOSTAGHIMI, Mississauga (CA); Kaveh KAHEN, North York (CA)

(21) Appl. No.: 18/293,006

(22) PCT Filed: Aug. 29, 2022
(86) PCT No.: PCT/CA2022/051304

§ 371 Date: Jan. 29, 2024

Related U.S. Application Data
(60) Provisional application No. 63/238,614, filed on Aug. 30, 2021.

(51) Int. Cl. H01J 49/10; H01J 49/06; H01J 49/42

(52) U.S. Cl. CPC H01J 49/105; H01J 49/063; H01J 49/423; H01J 49/4265

(57) ABSTRACT

A method and corresponding devices to reduce the presence of unwanted ions within the pseudo-potential well of the RF fields for inductively coupled plasma mass spectrometry is disclosed. This method reduces space-charge effects and leaves more room available for the ions of interest and, hence, leads to increased transmission of the desired ions into the mass analyzer. In the present invention, the space charge is reduced by adding a low-band resolving DC potential, or a fast sweeping resolving DC potential with a notch, or a fast constant resolving DC potential with a notch, or by adding auxiliary quadrupolar or dipolar RF potential to the quadrupole ion guide, such that all the unwanted ions will be outside the stable region and therefore ejected. This reduces the charge density in the ion beam and ameliorate space charge effects.

### FIELD OF THE INVENTION

This invention generally relates to mass spectrometers and specifically to a system and method to increase sensitivity of ICP-MS.

### BACKGROUND OF THE INVENTION

Inductively coupled plasma mass spectrometry (ICP-MS) is by far the most powerful technology for trace and ultra-trace elemental analysis. This technology provides detection limits as low as part per quadrillion (ppq), high sensitivity, wide dynamic range, and isotopic capability. The analytical capabilities of ICP-MS in this field are in part a result of its ion source, the ICP torch, which provides ionization temperatures as high as 10000 K, thereby facilitating the efficient atomization and ionization of sample species.

Despite the advantages provided by ICP-MS, this technology still suffers from some limitations. One of these limitations that has not been fully addressed to this day is the ion transmission efficiency. Typical detection efficiencies for current ICP-MS instruments are in the range of 10⁻⁴˜10⁻⁶ count/atom. Although, higher detection efficiencies at around 10⁻³ count/atom seem to have been achieved more recently with sector-field ICP-MS. The low transmission efficiency in ICP-MS is partially attributed to space charge effects. Space charge effects also cause mass discrimination in favor of heavier ions in comparison with lighter ones.

Space charge in ICP mass spectrometry happens due to the high number density of charged particles, which are sampled from the ICP through the sampler orifice. It has been estimated that the ion current passing through the skimmer orifice of an ICP-MS interface is in the range of 1.5 mA. Inside the ICP, the number of charge carriers (i.e., positive ions, negative ions, and electrons) are balanced. That is, the number of negative and positive charged particles is the same and, as such, the ICP is considered to be electrically neutral (i.e., globally-neutral) with no space charge fields. However, as the ions are sampled and enter the mass spectrometer, due to successive pressure drops in various stages of the mass spectrometer, electrons, which have much higher mobility compared to heavier ions, begin to be preferentially lost. Grounding of various components of the spectrometer (such as sample, skimmer, ion lenses, etc.) also contributes to the loss of electrons.

Ions of lower mass with lower kinetic energy are defocused more strongly and transmitted less efficiently than heavier ions with higher kinetic energies. The result is mass bias against light elements, which also contributes to matrix effects.

Various electrostatic fields commonly employed in the form of ion lenses to focus the positive ions also cause the electrons to be repelled from the ion beam. Therefore, the ion beam becomes successively more depleted from electrons. This leaves the ion beam to be mainly composed of positive ions. Since particles with the same charge repel each other due to Coulombic repulsion, this effect prevents the ion beam from being effectively focused using ion-beam guidance devices. As the ions proceed through various stages of the mass spectrometer, the ion beam is further defocused, and a great percentage of ions are lost. Therefore, ion-beam guidance devices in ICP-MS have a limited transmission ability which depends on the intensity and number density of the ion beam. This is known as the “space-charge limit”.

Commonly, the ion current sampled from the plasma into a typical ICP-MS device is around 1-1.5 mA, which is significantly above the few μA required to develop a strong space charge field. It is also claimed that matrix interferences are linked to changes in the ion transport process due to the influence of matrix ions on the space charge effect. Some authors reported that the actual ion current measured at the base of the skimmer is around 6-20 μA. These observations were later supported by the electron density measurements of Niu and Houk, time resolved measurements of the effect of matrix on the ion pulses by Allen et al. and Stewart and Olesik, and theoretical modeling of Tanner. The latter calculations support the observations that a strong defocusing of the ion beam is caused by space charge effects even at an ion current of only a few micro-Amperes. Furthermore, light ions with lower kinetic energies are less effectively transmitted than the heavier ions and more strongly defocused by matrix ions.

Previously various researchers tried to partially overcome the space charge effect in ICP-MS through various methods. For example, Praphairaksit and Houk implemented an additional electron source (in the form of a tungsten filament) inside the mass spectrometer after the skimmer to generate electrons (with an electron energy of at least 30 eV) to partially bring back the space charge neutrality of the ion beam and ameliorate the ion focusing process. Turner proposed acceleration of ions by applying a strong extraction potential downstream of the skimmer cone. This was done by implementing an acceleration cone having a bias potential of −2000V immediately after the skimmer cone to reduce number density and, hence, space charge effects. This method showed some minor improvement and did not solve the problem of mass bias and matrix effects.

A three-aperture interface was developed by Tanner et al. for this purpose. They used an off-axis aperture architecture after the skimmer cone to reduce the ion current and minimize the space charge. The natural disadvantage of this method is that a great portion of ions hit the aperture wall and become lost; although, an improvement in the limits of detection was reported.

In other approaches, the ion lenses were modified to reduce space charge through retaining the charge neutrality of the ion beam; for example by removing some of the ion lens components, or by applying a small positive bias potential on the extraction lenses. All of these techniques are either limited to the nature and kinetic energy of the matrix ions, result in a great percentage of the ions to be lost, or add complexity to the architecture and design of the mass spectrometer.

It is suggested that some of the matrix effects (non-spectroscopic interelement interferences) observed in ICP-MS instruments might be associated with the space charge effects in the ion optics and guides. Some studies also indicate that matrix elements play a dominant role in the ion beam where most of the matrix effects associated with ICP-MS are reported to originate when the ion beam travels between the skimmer and the ion extraction lenses.

Based on additional studies on the ion extraction process by Chambers et al. using a Langmuir probe, significant charge separation is considered to happen as the ions go from the sampler orifice to the skimmer orifice. These studies indicate that the assumption of charge neutrality at and beyond the skimmer orifice is not necessarily valid. Accordingly, the trajectory of ions inside the skimmer cone is greatly affected.

Space charge effects have been considered to be in part responsible for matrix effects and mass discrimination in ICP-MS. Computer simulations by Tanner indicate that the effect of space charge is significant as the ion beam travels downstream of the skimmer aperture. The ion current entering the skimmer orifice is shown to have a positive correlation with the degree of ion defocusing after the skimmer. Consequently, transmission efficiency was shown to decrease significantly for ion currents above 1-2 μA based on the simulations. It was also shown that heavier ions mostly remain around the central axis due to having higher kinetic energies. These ions can more easily penetrate the potential hill induced by space charge effect due to having higher energies. In contrast, lighter ions are defocused in the presence of heavier matrix ions due to having smaller kinetic energies. As a result of the accelerating potentials applied to the lenses and ion optics, the velocity increase for the heavier ions is less than that obtained by the lighter ones due to their mass. That is, heavier ions will move more slowly than lighter ions. Therefore, the heavier ions are better focused along the central axis which again contributes to an increased number density of heavy ions and their contribution to matrix effects. It was observed that as the current of ions entering the skimmer increases, the transmission efficiency of lighter ions is deteriorated to that of the heavier ones. In other words, transmission efficiency is a strong function of kinetic energy, where higher kinetic energies lead to better transmission efficiency.

As the ion beam travels downstream of the skimmer cone, the Debye length increases due to a decrease in ion density. This causes the electrons to diffuse away from the ion beam, thereby contributing to space charge effects. Isotope ratio measurements are also biased against the lower mass isotopes due to space charge effects. This effect is even more significant for elements with lighter mass. Some of the problems due to space charge may be partly overcome by generating more energetic ions which can be achieved by increasing the plasma potential or accelerating the ions as soon as possible after being sampled from the plasma.

In cases where an RF confinement field is used to focus the ion beam, the limited transmission capability depends on the “pseudo-potential well depth” of the RF field. Therefore, transmission of the atomic ions of interest is dependent on the presence of unwanted molecular/atomic ions. Specially, in an Ar ICP, most of the sampled ions are of argon which fill the pseudo-potential well of the RF field and leave less room for the ions of interest.

Here we describe methods to reduce the presence of unwanted ions within the pseudo-potential well of the RF fields, thereby reducing space-charge effects. This leaves more room available for the ions of interest and, hence, leads to increased transmission of the desired ions into the mass analyzer.

### BRIEF DESCRIPTION OF THE DRAWINGS

Embodiments herein will hereinafter be described in conjunction with the appended drawings provided to illustrate and not to limit the scope of the claims, wherein like designations denote like elements.

FIG. 1 shows the schematics of a typical ion guide.

FIG. 2A shows the Mathieu stability diagram for an ion guide with RF and DC fields. When no DC potential is applied, all ions with q>0.1 and q<0.9 have stable trajectory and pass through the ion guide.

FIG. 2B shows the Mathieu stability diagram for an ion guide with RF and DC fields. With applied DC potential, all ions above the line are stable, and all ions below the line are unstable and will be lost.

FIG. 3 shows a depiction of Mathieu stability diagrams for ions of various m/z, with the scan line, for a typical quadrupole filter. All ions are unstable below the DC scan line and will be ejected. All ions above the DC scan line are stable and will be transmitted.

FIG. 4 shows a first embodiment of the present invention. Reduction of space charge with added low-band resolving DC potential V_{DC}. All ions below the DC line (left) are unstable and will be ejected. All ions above the DC line are stable and will be transmitted.

FIG. 5 shows a second embodiment of the present invention. Reduction of space charge with added fast sweeping resolving DC potential V_{DC} with notch.

FIG. 6 shows a third embodiment of the present invention. Reduction of space charge with added fast constant resolving DC potential V_{DC} with notch.

FIG. 7 shows a fourth embodiment of the present invention. Reduction of space charge with added constant resolving DC potential V_{DC}.

FIG. 8 shows a fifth embodiment of the present invention. Time varying field with added auxiliary quadrupolar or dipolar RF potential V_{RF}.

FIG. 9 shows a sixth embodiment of the present invention. Reduction of space-charge with added broadband auxiliary quadrupolar or dipolar RF potential V_{RF} with a single notch.

FIG. 10 shows a seventh embodiment of the present invention. Reduction of space charge with added broadband auxiliary quadrupolar or dipolar RF potential V_{RF} with multiple notches.

FIG. 11 shows an eighth embodiment of the present invention that has a segmented ion guide.

FIG. 12 shows a ninth embodiment of the present invention in which reduction of space charge is by the 1^{st} segment of the ion guide, and trap/release of the ions in the 2^{nd} segment in order to increase sensitivity.

FIG. 13 shows a tenth embodiment of the present invention in which trapping all ions can happen in the 1^{st} segment of the ion guide by applying a rod offset on the 2^{nd} segment. Space charge is reduced in the 1^{st} segment of the ion guide by auxiliary excitation. Then the desired ions are transported in the 2^{nd} segment to increase sensitivity.

FIG. 14 shows an eleventh embodiment of the present invention for axial ejection of ions of interest.

### DETAILED DESCRIPTION

Exemplary embodiments of the present invention are described in the following paragraphs with referring to the figures and without limiting the scope of the invention.

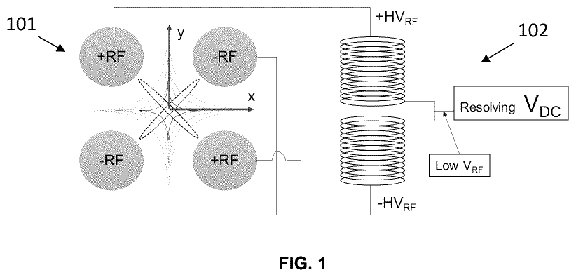

Initially, a general description of time-varying fields is provided. FIG. 1 shows the schematics of an ion guide, composed of four parallel rods 101, with a time-varying radio-frequency (RF) field and an added resolving direct current (DC) potential V_{DC} 102. These fields may be defined as follows:
DC Resolving field:

$${E}_{DC} = \frac{{V}_{DC}}{{r}_{0}^{2}} \times i \qquad ( 1 )$$

where i=x, y, z
RF Trapping field:

$${E}_{RF} = \frac{{V}_{RF}}{{r}_{0}^{2}} cos ( ω t ) \times i \qquad ( 2 )$$

where E_{DC} is the electric field due to the applied resolving DC potential, V_{DC} is the resolving DC potential applied to the rods, E_{RF} is the field due to the RF potential, V_{RF} is the amplitude of the RF voltage applied to the rods, r₀ is half the distance between two opposing rods, and ω is the angular frequency of the RF field.

Typically, a positive potential is applied to two opposing rods and a potential with the same amplitude but negative polarity is applied to the other two rods, as shown in FIG. 1. The resulting field inside the rods is determined by superposing the RF and DC fields in the following form:

$${E}_{i} = [ \frac{{V}_{DC}}{{r}_{0}^{2}} + \frac{{V}_{RF}}{{r}_{0}^{2}} cos ( ω t ) ] i \qquad ( 3 )$$

The ions enter the space between the four rods along the z axis (along the rods, not shown). These ions maintain their velocity along the z axis as they travel through the mass spectrometer. However, they will be subject to forces in the x and y directions due to the RF and DC fields. Based on Newton's second law and Coulomb's law, the force acting on a charged particle inside the rods can be defined as:

$$F = ma = EeZ where a = \frac{{d}^{2} i}{{dt}^{2}} \qquad ( 4 )$$

in which F is the force acting on the particle, m is the mass of particle, a is acceleration, e is the elementary charge, and Z is the number of charges per particle. By substituting Et into the above equation, a second order differential equation is obtained as below:

$$m \frac{{d}^{2} i}{{dt}^{2}} = 2 eZ [ \frac{{V}_{DC}}{{r}_{0}^{2}} + \frac{{V}_{RF}}{{r}_{0}^{2}} cos ( ω t ) ] i \qquad ( 5 )$$

In other words, the equations of motion for a charged particle inside the rods in the x and y (plane of the cross section of the rods, not shown) directions can be arranged as:
x direction:

$$\frac{{d}^{2} x}{{dt}^{2}} + \frac{2 eZ}{{mr}_{0}^{2}} [ {V}_{DC} + {V}_{RF} cos ( ω t ) ] x = 0 \qquad ( 6 )$$

y direction:

$$\frac{{d}^{2} y}{{dt}^{2}} - \frac{2 eZ}{{mr}_{0}^{2}} [ {V}_{DC} + {V}_{RF} cos ( ω t ) ] y = 0 \qquad ( 7 )$$

Based on these equations, the position of each ion within the rods can be determined at any given time. As long as the x and y coordinates for an ion inside the rods remain less than r₀, the ion will pass through without hitting the rods. Otherwise, the ion is considered unstable, hits one of the rods and is lost. Mathieu [26] has provided a solution for the following form of differential equation:

$$\frac{{d}^{2} i}{d {ξ}^{2}} + [ {a}_{i} - 2 {q}_{i} cos ( 2 ξ ) ] i = 0 ; i = x , y , z \qquad ( 8 )$$

By comparing this equation with the ones obtained above, using a change of variable in the form of ξ=ωt/2, the equation of motion for charged particles can be written in the form of Mathieu equation. Consequently, a comparison readily reveals that:
x direction:

$$a = {a}_{x} = - {a}_{y} = \frac{8 {eV}_{DC}}{{r}_{0}^{2} {ω}_{0}^{2}} \frac{1}{m / Z} \qquad ( 9 )$$

y direction:

$$q = {q}_{x} = - {q}_{y} = \frac{4 {eV}_{RF}}{{r}_{0}^{2} {ω}_{0}^{2}} \frac{1}{m / Z} \qquad ( 10 )$$

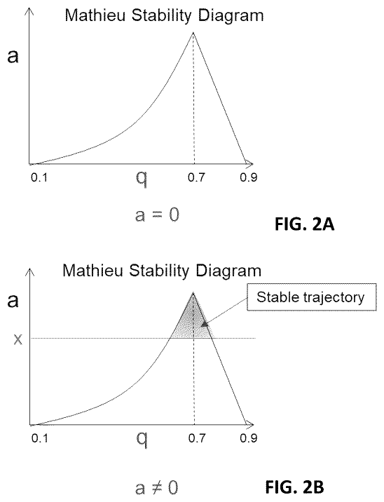

The solution of the Mathieu equation leads to a set of solutions for which the ions would be stable and pass through the ion guide. FIG. 2 shows the Mathieu stability diagram plotted for different values of a and q for an ion of m/z. Typically, r₀ and ω are constant in an instrument. Therefore, by changing the values of V_{DC} and V_{RF}, various ions with different m/z are allowed to pass through the ion guide.

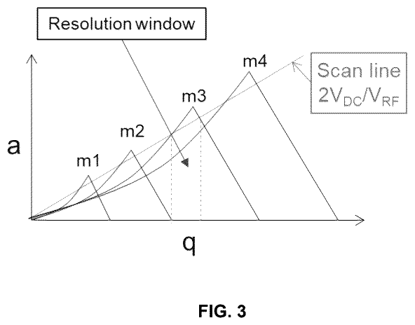

In the case where a DC potential is applied to the rods (as shown in FIG. 2, bottom), the area confined between the Mathieu stability boundaries and the DC scan line denotes the stable region. Therefore, all the ions that fall above the line and within the stability area would be stable and pass through the ion guide. In contrast, all the ions below the line would be unstable and will be lost by hitting the rods. FIG. 3 shows the scan line with a slope of 2V_{DC}/V_{RF}.

For an ion traveling through the rods, the motion frequency of the ion (i.e., the resonance frequency, ωᵣₑₛ) is given by:

$${ω}_{res} = \frac{{2}^{1 / 2} {eZV}_{RF}}{{mr}_{0}^{2} {ω}_{0}} = \frac{{2}^{1 / 2} {eV}_{RF}}{{r}_{0}^{2} {ω}_{0}} \frac{1}{m / Z}$$

The number of ions that can be contained in an ion guide is proportional to its potential well depth. The size of the potential well depth depends on the ion guide geometry, applied RF voltage and frequency, and mass of the ion. Therefore, based on Dehmelt approximation, the potential well depth D can be defined as:

$$D = {CqV}_{RF} = C \frac{{eV}_{RF}^{2}}{{r}_{0}^{2} {ω}_{0}^{2}} \frac{1}{m / Z}$$

When the number density of charged particles entering the ion guide is higher than what the ion guide can accept based on its potential well depth, some of the ions will not be allowed to enter and will be lost. In such a case, it would be desirable to prevent the unwanted ions from entering the ion guide in order to maximize the number of ions of interest to enter the ion guide. As such, reducing the space charge effects for an ion guide is desirable.

For pressurized ion guides, at pressures between (0-50 mbar), Mathieu boundary conditions are intact and well-defined. Collision of ions with the background gas cause them to lose radial and axial energy and be focused to the centerline of the ion guide. This is called “collisional focusing”.

An auxiliary excitation would cause the ions to gain radial energy (50-100 eV), overcome the confinement field, and therefore be ejected out of the space between the rods. This can be used to eject the unwanted ions and reduce space charge effects within the ion guide. Auxiliary excitation can be achieved by methods such as applying resolving DC or radial RF dipolar/quadrupolar excitation based on the Mathieu stability diagram.

Auxiliary excitation can be achieved by the following methods: By applying resolving DC potential to the rods; by applying an RF dipolar or quadrupolar field; by performing near-instability excitation (i.e., at q=0.85-0.9), and by 2-D to 3-D field conversion, where for ions of a selected mass to charge ratio, some of the ion's radial energy converts into axial energy. This is known as axial ejection.

Unstable ions typically gain energy (≈50-100 eV) before being ejected. This gain of radial energy by the ions induces ion fragmentation, de-clustering, or ejection, depending on the pressure within the ion guide. At pressures above 50 mbar, Mathieu parameters will shift and require adjustment.

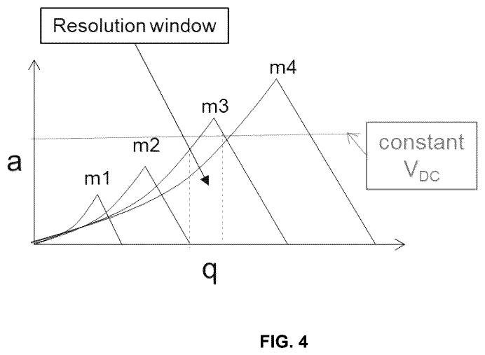

FIG. 4 shows the first embodiment of the present invention. In this case, the reduction of space charge is accomplished by adding a low-band resolving DC potential V_{DC} through a DC voltage source. In this case, all ions having a low mass are ejected out. This will reduce the charge density in the ion beam and ameliorate space charge effects.

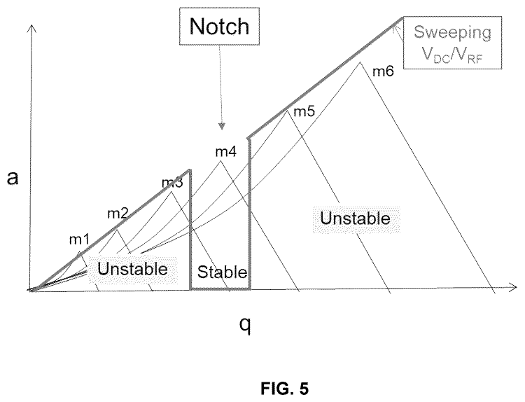

FIG. 5 shows a second embodiment of the present invention, in which all the ions outside the stable region within the notch will be unstable and therefore ejected. This is accomplished by an added fast sweeping resolving V_{DC} with a notch through a DC power supply. Again this will reduce the space charge by ejecting a portion of the unwanted ions.

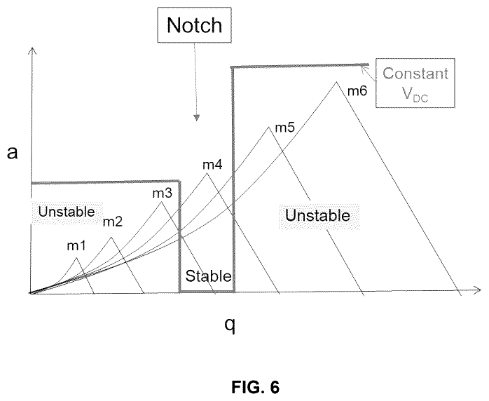

FIG. 6 shows a third embodiment of the present invention, in which all the ions outside the stable region within the notch will be unstable and therefore ejected. In this case, this is accomplished by an added fast constant resolving V_{DC} with a notch.

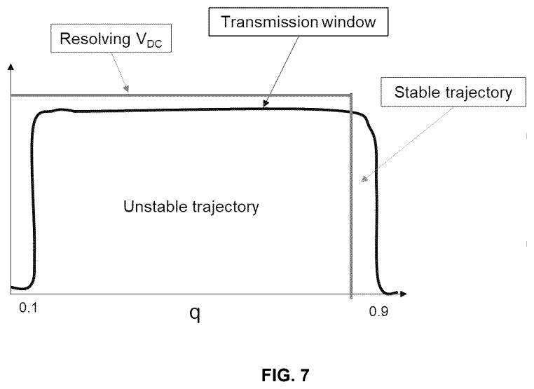

Another embodiment of the present invention is shown in FIG. 7. In this case, a constant resolving DC potential has been added through a DC voltage source. All ions outside the stable region will be unstable and ejected. Heavy ions having q>0.9 are unstable and will be ejected.

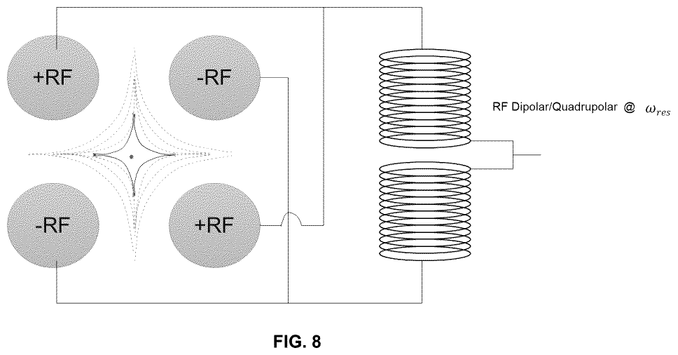

Another method for reducing the effects of space charge is by adding auxiliary quadrupolar or dipolar RF potential V_{RF} to the quadrupole. This is shown in FIG. 8. In this case, the resonance frequency of an ion with mass-to-charge ratio m/z is defined as:

$${ω}_{res} = \frac{{2}^{1 / 2} {eV}_{RF}}{{r}_{0}^{2} {ω}_{0}} \frac{1}{m / Z}$$

As a result of applying the auxiliary quadrupolar and dipolar RF potential, ions that have a resonance frequency equivalent to the frequency of the auxiliary RF field will gain radial energy inside the quadrupole. These ions will either be radially ejected out (i.e., radial ejection), become fragmented, or become de-clustered.

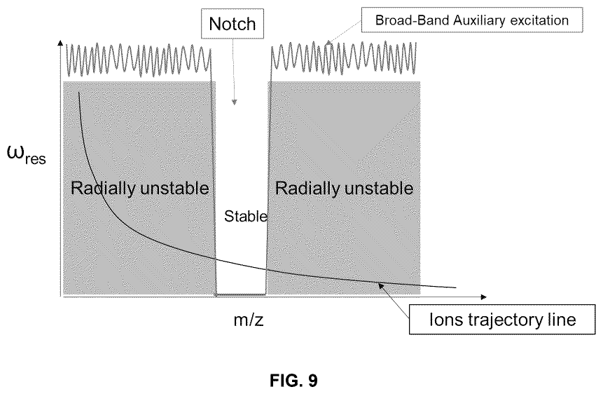

FIG. 9 shows an embodiment of the present invention in which the space charge effects is reduced by adding a broadband auxiliary quadrupolar or dipolar RF potential V_{RF} with a single notch. This can be superposed on top of the RF potential already applied to the rods by implementing a broadband waveform source in the system. This field can have a wide range of frequencies to cover the resonance frequency of a range of ions with various mass-to-charge ratios that are desired to be ejected. At the same time, the electronic circuitry can be designed in a way to be able to desirably remove a small band of frequencies (i.e., notch) from the waveform in accordance with the resonance frequencies of the ions of interest. Therefore, all the ions having m/z values that fall within the notch will be stable and pass through the quadrupole. The rest of the ions will be radially ejected, fragmented, or decluttered due to excitation by the added auxiliary RF potential.

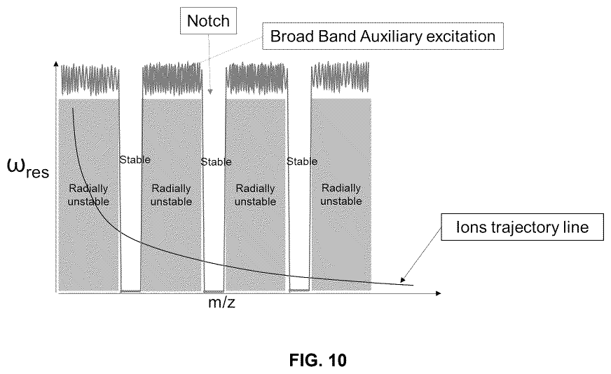

FIG. 10 shows another embodiment of the present invention in which a broadband auxiliary quadrupolar or dipolar RF potential V_{RF} has been added which has multiple notches instead of one. Again, multiple portions of the waveform can be removed as desired. In this case, all the ions having m/z that fall within any of the notches will be stable and pass through the quadrupole. The rest of the ions will experience resonant excitation by the auxiliary RF field. Therefore, these ions are radially unstable and will be ejected, fragmented, or de-clustered. This will reduce the charge density and ameliorate space charge effects.

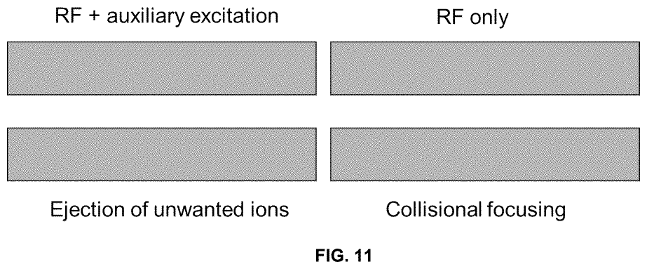

FIG. 11 shows another embodiment of the present invention. In this case, the ion guides are separated into two segments. The first segment serves to eject the unwanted ions by auxiliary excitation through one of the methods described above. The second ion guide segment then works to accumulate and transport the ions of interest which exit the first segment. In this way, the charge density in the ion beam is reduced in the first segment, therefore the focusing of the ion beam in the second segment can be accomplished more conveniently due to the reduced space charge effect.

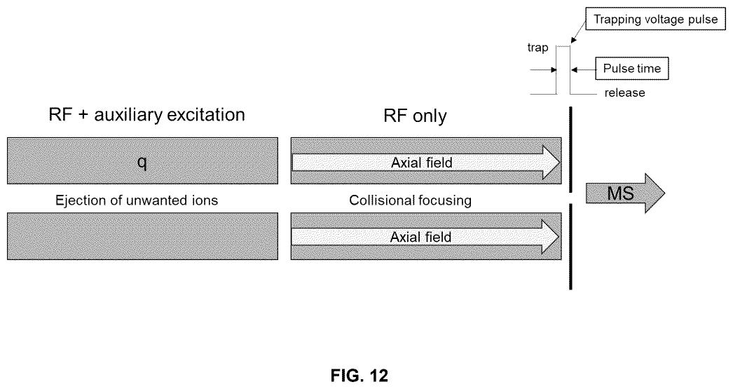

Another embodiment of the present invention is shown in FIG. 12. In this case, the ion guide is similarly separated into two segments. An exit lens voltage is also accompanied after the second segment. The first segment ejects, fragments, or de-clusters the unwanted ions by applying auxiliary excitation through one of the methods described above. In this case the ion number density is decreased, leading to reduced space charge in the second segment. Then, to improve sensitivity, the ions of interest can be trapped and transported in the second segment by pulsing the voltage applied on the exit lens. By carefully adjusting the pulse period and height through the electronic system, the potential well of the ion guide can be fully filled to maximize the transport of the desired ions. An axial field may also be applied using a DC voltage source to accelerate and drive the ions trapped in the second segment out of the ion guide towards the next stage of the mass spectrometer. Similarly, collisional focusing in the second segment is accomplished more conveniently due to the reduced space charge effect.

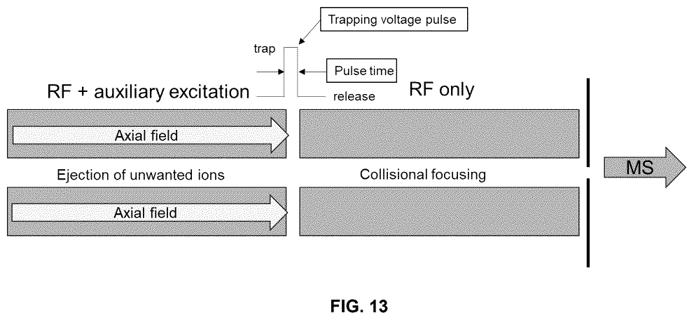

FIG. 13 shows another embodiment of the present invention. In this case, similarly the space charge can be reduced in the first segment by applying auxiliary excitation based on one of the methods described above. Here, instead of pulsing the voltage applied to the exit ion lens, a rod offset is applied to the 2^{nd} segment of the ion guide. By pulsing the rod offset, the ions of interest can be trapped inside the first segment, and then transported and collisionally-focused in the second segment. By carefully adjusting the pulse period and height, the potential well depth of the ion guide can be fully filled to maximize the transport of ions and, hence, sensitivity. An axial field may also be applied to drive and transport the trapped ions out of the ion guide.

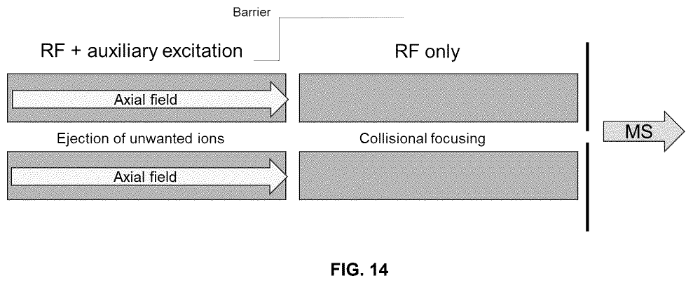

Another embodiment of the present invention is schematically shown in FIG. 14. Similarly, the space charge is reduced in the first segment by applying auxiliary excitation based on one of the methods described above. Here the process is that by applying a rod offset on the second segment of the ion guide, a constant potential barrier is formed with a given barrier height. This will cause all the ions to be trapped in the 1^{st} segment of the ion guide. Then, radial excitation of the ions of interest will be performed by the methods described above. Subsequently, the radial energy is partially converted into axial energy. This gain in axial energy for the ions of interest will allow them to penetrate through the barrier. Similarly, the second ion guide segment is used to focus the ions that exit the first segment and transmit them to the later stages of the mass spectrometer. In this way, transport and focusing of the ions of interest is carried out more conveniently within the second segment, since all the unwanted ions are not allowed to enter the second segment, leading to decreased ion density and hence, space charge effects.

1. An inductively coupled plasma mass spectrometer (ICP-MS) system for analyzing chemical species, comprising:
a) at least one ion source to generate ions from a sample substance;
b) a vacuum chamber having at least one vacuum stage;
c) means for transmitting ions from said at least one ion source into the vacuum chamber;
d) an ion guide comprising of at least one multipole ion guide within the vacuum chamber having a plurality of poles and at least one default radio-frequency (RF) potential and one or a set of default direct current (DC) potentials independently applied to the ion guide to create a confinement field within the ion guide and to receive and transmit ions within a range of mass-to-charge ratios;
e) an auxiliary excitation system coupled to the ion guide to subject unwanted ions within a predefined range of mass-to-charge ratio to an auxiliary excitation, whereby a set of unwanted ions gain enough energy to overcome said confinement field to be ejected out of the ion guide, or to be fragmented, or to be de-clustered, thereby filtering out and eliminating the set of unwanted ions to reduce a charge density and thereby, a space charge within the ion guide to improve transmission of a set of remaining ions that are a set of desired ions by the ion guide;
f) at least one mass analyzer inside the vacuum chamber to receive and analyze said set of remaining ions transmitted by the ion guide, and
g) at least one ion detector inside the vacuum chamber to detect said set of remaining ions analyzed by the said at least one mass analyzer.

2. The system of claim 1, wherein said at least one ion source is an inductively coupled plasma torch.

3. The system of claim 1, wherein the ion guide comprises of an RF-only quadrupole rod set.

4. The system of claim 1, wherein said means for transmitting ions coupled to the ion guide comprises of a resolving direct current (DC) potential V_{DC}, an RF dipolar or quadrupolar field, a near-instability excitation, or a 2-D to 3-D field conversion.

5. The system of claim 1, wherein said auxiliary excitation system coupled to the ion guide comprises of a DC potential source to provide a constant DC potential to the ion guide, wherein the constant DC potential is configured to make the set of unwanted ions that have a mass-to-charge ratios lower than a predefined mass-to-charge ratio unstable and eject them out of the ion guide.

6. The system of claim 1, wherein said auxiliary excitation system coupled to the ion guide comprises a DC potential source to provide a fast-sweeping resolving DC potential to the ion guide, said fast-sweeping resolving DC potential having at least one notch to create at least one stable mass-to-charge ratio range within the notch for a set of desired ions and to make all other mass-to-charge ratio ranges out of the notch unstable, thereby ejecting unwanted ions having mass-to-charge ratio values outside the notch out of the ion guide.

7. The system of claim 1, wherein said auxiliary excitation system coupled to the ion guide comprises a DC potential source to provide a fast stepwise resolving DC potential to the ion guide, said stepwise resolving DC potential having at least one notch to create at least one stable mass-to-charge ratio range within the notch for the set of desired ions and to make all other mass-to-charge ratio ranges out of the notch unstable, thereby ejecting unwanted ions having mass-to-charge ratio values outside the notch out of the ion guide.

8. The system of claim 1, wherein said default radio-frequency (RF) potential applied to the ion guide creates a transmission window for the range of mass-to-charge ratios associated with a q parameter between 0.1 to 0.9, and wherein said auxiliary excitation system coupled to the ion guide comprise a DC potential source to apply a constant resolving DC potential to the ion guide to make ions having a q parameter below a predefined mass-to-charge ratio unstable and only allow desired ions having a q parameter above said predefined mass-to-charge ratio to be stable and pass through the ion guide.

9. The system of claim 1, wherein said auxiliary excitation system coupled to the ion guide comprises a secondary RF potential source to provide a broadband auxiliary RF dipolar or quadrupolar field to the ion guide, said broadband auxiliary field having a range of RF frequencies to resonate with resonance frequencies of ions within a predefined range of mass-to-charge ratios, wherein said auxiliary excitation system further comprises a notch formed by removing at least one predefined RF frequency band from said range of RF frequencies, whereby the set of desired ions are stable, thereby making unwanted ions having resonance frequencies outside said notch unstable, thereby causing unwanted ions to gain radial energy to fragment, de-cluster, and/or eject out of the ion guide.

10. The system of claim 9, wherein the broadband auxiliary RF dipolar or quadrupolar field applied to the ion guide comprises multiple notches in which the set of desired ions are stable and out of which the set of unwanted ions are unstable and will be fragmented, de-clustered, and/or ejected out of the ion guide.

11. The system of claim 1, wherein the ion guide is segmented having at least two segments comprising a first segment and a second segment, and wherein said default RF potential is applied to both segments, and wherein said auxiliary excitation is applied only to the first segment to eject unwanted ions out of the first segment to reduce space charge and improve collisional focusing and transmission of desired ions by the second segment, and wherein the second segment is further used to accumulate or transmit the set of desired ions received from the first segment.

12. The system of claim 11, wherein said auxiliary excitation is a low-band resolving direct current (DC) potential or a broadband auxiliary quadrupolar or dipolar radio-frequency (RF) potential.

13. The system of claim 11, wherein an exit lens is added at the exit of the second segment, and wherein a pulsating DC potential is applied on the exit lens, wherein a pulse period and a pulse height of said pulsating DC potential is configured to trap the set of desired ions received by the second segment until a potential well of the second segment is completely filled with the set of desired ions, and wherein said DC potential can be removed to let a set of trapped desired ions pass through the exit lens altogether, thereby improving the sensitivity of the system.

14. The system of claim 13, further comprising an axial field applied to the second segment to drive the set of trapped desired ions through the exit lens altogether, thereby improving the sensitivity of the system.

15. The system of claim 11, further comprising an offset potential applied to the second segment or a trapping potential pulse between the two segments until potential well of first segment is completely filled, and wherein unwanted ions are ejected out of the first segment through auxiliary excitation followed by transmitting the set of desired ions out of the first section into the second section by removing said offset potential or said trapping potential pulse or by applying an axial field to the first segment, thereby reducing space charge and improving transmission and collisional focusing of desired ions by the second segment, and wherein an exit lens may be placed at the exit of the second segment to pull the desired ions out of the second segment, thereby improving sensitivity of the system.

16. The system of claim 15, further having a barrier potential with an adjustable height constantly applied between the two segments to trap the ions inside the first segment, and wherein means are coupled to the first segment to apply radial excitation to the trapped ions within the first segment, and wherein said means coupled to the first segment are configured to only excite the desired ions in which the radial energy of desired ions convert into axial energy to cause only the desired ions to pass into the second segment, thereby reducing space charge in the second segment and improve collisional focusing and transmission of desired ions in the second segment, thereby improving sensitivity of the system.

17. A method for reducing space charge in a mass spectrometer having an ion source and at least one multipole ion guide having a plurality of poles and a confinement field to transport an ion beam having ions, comprising the steps of:
a. applying an RF potential comprising of a time-varying radio-frequency (RF) to the ion guide and one or a set of default direct current (DC) potentials to create a confinement field within the ion guide and to receive and transmit the ions within a broad range of mass-to-charge ratios, and
b. applying an auxiliary excitation to the ions passing through the ion guide to produce a low charge density ion beam and ameliorate a space charge, whereby the auxiliary excitation causes ions to gain radial energy, overcome the confinement field, and be ejected out of a space between the plurality of poles of the ion guide, or be fragmented, or be de-clustered, and thereby unwanted ions are eliminated or ejected and the space charge within the ion guide is reduced.

18. The method of claim 17, wherein the auxiliary excitation is by a resolving direct current (DC) potential, V_{DC}, by an RF dipolar or quadrupolar field, by performing near-instability excitation, or by 2-D to 3-D field conversion, whereby for ions of a selected mass to charge ratio, some of the ion's radial energy converts into axial energy, causing axial ejection of ions.

19. The method of claim 17, wherein the auxiliary excitation is a low-band resolving direct current (DC) potential with a constant voltage having a notch, wherein ions outside a stable region within the notch are unstable and therefore ejected, whereby the space charge is reduced by ejecting a portion of unwanted ions.

20. The method of claim 17, wherein the auxiliary excitation is a low-band resolving direct current (DC) potential, V_{DC}, with a sweeping voltage having a notch, wherein ions outside the stable region within the notch are unstable and therefore ejected.

21. The method of claim 17, wherein the auxiliary excitation is a broadband auxiliary quadrupolar or dipolar RF potential V_{RF}, to radially eject or fragment or de-cluster ions, whereby ions having mass-to-charge ratio, m/z, with a resonance frequency equal to an RF frequency of the RF potential gain radial energy inside the quadrupole, and get radially ejected, become fragmented, or become de-clustered.

22. The method of claim 21, wherein the broadband auxiliary quadrupolar or dipolar RF potential V_{RF}, has a single notch, whereby ions having m/z that fall within the single notch are stable and pass through the quadrupole, and remaining ions are radially ejected, fragmented, or decluttered.

23. The method of claim 21, wherein the broadband auxiliary quadrupolar or dipolar RF potential V_{RF}, has a plurality of notches, wherein ions having m/z that fall within each notch are stable and pass through the quadrupole, and remaining ions are radially unstable and are ejected, fragmented, or de-clustered, thereby reducing the charge density and ameliorate space charge effects.

24. The method of claim 16, wherein the ion guide has a first segment and a second segment to guide an ion beam, and wherein the time-varying radio-frequency (RF) field is applied to the first and the second segments, and the auxiliary excitation is applied to the first segment to produce a low charge density ion beam and ameliorate a space charge effect, wherein the added excitation is a low-band resolving direct current (DC) potential, V_{DC}, or a broadband auxiliary quadrupolar or dipolar RF potential V_{RF}, wherein providing the low charge density ion beam from the first segment to the second segment and trap/release ions of interest in the second segment to produce a set of desired ions.

25. The method of claim 24, further providing an exit lens voltage after the second segment to improve sensitivity.

26. The method of claim 25, wherein the exit lens voltage is a pulsating voltage, and wherein by adjusting a pulse period and a pulse height of the pulsating voltage, the potential well of the first segment of the ion guide is fully filled to maximize the transport of the set of desired ions.

27. The method of claim 26, further applying an axial field to accelerate and drive ions trapped in the second segment out of the ion guide towards a next stage of the mass spectrometer, whereby collisional focusing in the second segment is accomplished due to the reduced space charge effect.

28. The method of claim 24, further applying a rod offset to the second segment of the ion guide.

29. The method of claim 28, further pulsating the rod offset, wherein the set of desired ions can be trapped inside the first segment, and then transported and collisionally-focused in the second segment, and by adjusting the pulse period and the pulse height, the potential well of the ion guide is filled to maximize transport of ions and sensitivity.

30. The method of claim 29, further applying an axial field to drive and transport trapped ions out of the ion guide.

31. The method of claim 28, wherein the rod offset is configured to form a constant potential barrier with a given barrier height, causing ions to be trapped in the first segment of the ion guide, and then, a radial excitation of the set of desired ions is performed by applying a low-band resolving direct current (DC) potential, V_{DC}, or a broadband auxiliary quadrupolar or dipolar RF potential V_{RF}, thereby the radial energy is partially converted into axial energy, which results in gain in axial energy for the set of desired ions and allows them to penetrate through the barrier, and the second segment is used to focus ions that exit the first segment and transmit them to later stages of the mass spectrometer, and in this way, transport and focusing of the set of desired ions is carried out more conveniently within the second segment, since all unwanted ions are not allowed to enter the second segment, leading to decreased ion density and hence, space charge effects.

32. A space charge reduction system for a mass spectrometer, the system comprising:
a) an ion guide comprising of at least one multipole ion guide and a set of rods and having a confinement field to transport an ion beam having ions;
b) an RF source to generate and apply a time-varying radio-frequency (RF) on the ion guide, and one or a set of default direct current (DC) potentials to create the confinement field within the ion guide and to receive and transmit ions within a broad range of mass-to-charge ratios;
c) an auxiliary source to generate and apply an auxiliary excitation on the ion guide to produce a low charge density ion beam and ameliorate a space charge effect, whereby the auxiliary excitation causes ions to gain radial energy, overcome the confinement field, and be ejected out of a space between the set of rods of the ion guide, and thereby unwanted ions are ejected and the space charge within the ion guide is reduced.

33. The system of claim 32, wherein the auxiliary excitation is a resolving direct current (DC) potential, V_{DC}, an RF dipolar or quadrupolar field, a near-instability excitation, or 2-D to 3-D field conversion, wherein for ions of a selected mass to charge ratio, some of the ion's radial energy converts into axial energy, causing axial ejection of ions.

34. The system of claim 33, further having an exit lens placed after the second segment and an exit lens voltage applied on the exit lens to improve sensitivity, wherein the exit lens voltage is constant or pulsating, wherein by adjusting a pulse period and a pulse height of the exit lens voltage, a potential well of the ion guide is fully filled to maximize transport of a set of desired ions.

35. The system of claim 33, further having an axial field to accelerate and drive the ions trapped in the second segment out of the ion guide towards a next stage of the mass spectrometer, whereby collisional focusing in the second segment is accomplished more conveniently due to the reduced space charge effect.

36. The system of claim 33, further having a constant or a pulsating rod offset at the second segment of the ion guide, wherein a set of desired ions are trapped inside the first segment, and then transported and collisionally-focused in the second segment, and by adjusting the pulse period and the height of the rod offset, the potential well of the ion guide is fully filled to maximize the transport of ions and, hence, sensitivity.

37. The system of claim 33, wherein the ion guide is a quadrupole ion guide.
